(19) United States
(12) Patent Application Publication
(10) Pub. No.: US 2026/0235068 A1
(43) Pub. Date: Aug. 13, 2026

(54) ENGINE

(71) Applicants: ISHIKAWA ENERGY RESEARCH CO., LTD., Ota-shi, Gunma (JP); KUBOTA CORPORATION, Osaka-shi, Osaka (JP)

(72) Inventors: Toru Kano, Ota-shi, Gunma (JP); Taro Fukuda, Ota-shi, Gunma (JP)

(73) Assignees: ISHIKAWA ENERGY RESEARCH CO., LTD., Ota-shi, Gunma (JP); KUBOTA CORPORATION, Osaka-shi, Osaka (JP)

(21) Appl. No.: 19/155,649

(22) PCT Filed: Jul. 31, 2023
(86) PCT No.: PCT/JP2023/027906

§ 371 Date: Aug. 12, 2025

(51) Int. Cl. F02B 75/28; F02F 1/24

(52) U.S. Cl. CPC F02B 75/28; F02F 1/242

(57) ABSTRACT

The present invention provides an engine in which the positions of each valve and a spark plug are optimized with respect to an extension space. The engine 10 comprises: a cylinder chamber 12, an intake valve 18, an exhaust valve 19, and a spark plug 26. Inside the cylinder chamber 12, opposing pistons are arranged so as to reciprocate. An extension space 33 is a space continuous from an intermediate portion of the cylinder chamber 12 toward a side. On a first side surface 3313 of the extension space 33, a first intake valve 181 is arranged. On a second side surface 3314 of the extension space 33, which opposes the first side surface 3313, a first exhaust valve 191 and a first spark plug 261 are arranged.

### TECHNICAL FIELD

The present invention relates to an engine, and particularly, relates to an opposed-piston engine.

### BACKGROUND ART

Conventionally, opposed-piston engines, as shown in Patent Literature 1 and Patent Literature 2, commonly had a structure in which pistons having piston heads that face each other perform linear motion within one cylinder arranged in a horizontal direction. Within this cylinder, the region where the piston heads face each other functions as a combustion chamber, and by an air-fuel mixture undergoing ignition and explosion, the pistons operate, and power is supplied to an external actuator such as a generator.

However, in the engines described in such patent literatures, because the combustion chamber volume is small, a high compression ratio is difficult, and there is also an issue with insulating the combustion chamber. Also, the intake and exhaust valves of conventional opposed-piston engines are directly open to the combustion chamber, and there was a drawback that the volume of the combustion chamber becomes large.

In order to solve such issues, the engine described in Patent Literature 3 was invented. In the engine described in Patent Literature 3, independent left and right pistons are arranged within a horizontal cylinder so as to face each other. Also, between the left and right piston heads, one combustion chamber is formed, communicating with the outside of the horizontal cylinder. Furthermore, in the engine described in Patent Literature 3, an extension part extending laterally from the combustion chamber is formed. In this extension part, a spark plug is provided.

### CITATION LIST

### Patent Literature

Patent Literature 1: Japanese Patent Application Publication No. 2007-46534

Patent Literature 2: Japanese Patent Application Publication No. Hei 8-93498

Patent Literature 3: Japanese Patent No. 5508604

### SUMMARY OF THE INVENTION

### Technical Problem

However, in the opposed-piston engines described in the aforementioned patent literatures, there was room for improvement from the viewpoint of optimizing the arrangement of valves and the like.

Specifically, in the opposed-piston engine described in Patent Literature 3, when the direction in which the pistons reciprocate is taken as the front-rear direction, the intake valve and the exhaust valve were collectively arranged to the front or rear of the extension part. Furthermore, the advancing/retreating mechanisms for the intake valve and exhaust valve, and spark plugs, also are consolidated on the side where the intake valve and exhaust valve are arranged.

For this reason, by the intake valve, exhaust valve, advancing/retreating mechanism, spark plug, and the like being consolidated on one side of the extension part, the engine becomes long in the width direction, and there was an issue that making the engine compact is not easy.

Furthermore, when an opposed-piston engine is made multi-cylinder, it is conceivable that such issues become prominent.

The present invention has been made in view of such problems, and an object of the present invention is to provide an engine in which the positions of each valve, spark plug, and the like are optimized with respect to the extension space.

### Solution to Problem

An engine of the present invention comprises: a cylinder chamber, an intake valve, an exhaust valve, and a spark plug, wherein inside the cylinder chamber, opposing pistons are arranged so as to reciprocate, an extension space, which is a space extending from a side surface of the cylinder chamber along a direction orthogonal to a central axis of the cylinder chamber, is formed, on a first side surface of the extension space, the intake valve is arranged, and on a second side surface of the extension space, which opposes the first side surface, the exhaust valve and the spark plug are arranged.

Also, in the engine of the present invention, the number of the exhaust valves is less than the number of the intake valves.

Also, in the engine of the present invention, inside the extension space, an electrode formed at a tip of the spark plug is closer to the central axis of the cylinder chamber than an extension line of a central axis of the intake valve and an extension line of a central axis of the exhaust valve.

Also, in the engine of the present invention, the cylinder chamber has a first cylinder chamber, and a second cylinder chamber adjacent to the first cylinder chamber in a width direction, the extension space has a first extension space formed in the first cylinder chamber, and a second extension space formed in the second cylinder chamber, the intake valve has a first intake valve attached to the first extension space, and a second intake valve formed in the second extension space, the exhaust valve has a first exhaust valve attached to the first extension space, and a second exhaust valve formed in the second extension space, and the spark plug has a first spark plug attached to the first extension space, and a second spark plug attached to the second extension space.

Also, in the engine of the present invention, the first spark plug is arranged outward in the width direction from the first exhaust valve, and the second spark plug is arranged outward in the width direction from the second exhaust valve.

Also, in the engine of the present invention, the first cylinder chamber and the second cylinder chamber are formed inside an engine block, and the first spark plug and the second spark plug are arranged in installation holes that penetrate a side surface portion of the engine block.

### Advantageous Effects of Invention

An engine of the present invention comprises: a cylinder chamber, an intake valve, an exhaust valve, and a spark plug, wherein inside the cylinder chamber, opposing pistons are arranged so as to reciprocate, an extension space, which is a space extending from a side surface of the cylinder chamber along a direction orthogonal to a central axis of the cylinder chamber, is formed, on a first side surface of the extension space, the intake valve is arranged, and on a second side surface of the extension space, which opposes the first side surface, the exhaust valve and the spark plug are arranged. According to the engine of the present invention, because the intake valve is arranged on the first side surface of the extension space, and the exhaust valve and the spark plug are arranged on the second side surface of the extension space, the width of the extension space can be narrowed. Consequently, with such a configuration, miniaturization of the entire engine can be realized. Furthermore, an electrode portion formed at the tip of the spark plug can be brought closer to a center of the extension space and the cylinder chamber, and flame propagation in the extension space and the cylinder chamber can be suitably performed.

Also, in the engine of the present invention, the number of the exhaust valves is less than the number of the intake valves. According to the engine of the present invention, because the number of exhaust valves is small, a space for attaching the spark plug can be secured in the vicinity of the exhaust valve.

Also, in the engine of the present invention, inside the extension space, an electrode formed at a tip of the spark plug is closer to the central axis of the cylinder chamber than an extension line of a central axis of the intake valve and an extension line of a central axis of the exhaust valve. According to the engine of the present invention, flame propagation in the extension space and the cylinder chamber can be performed favorably.

Also, in the engine of the present invention, the cylinder chamber has a first cylinder chamber, and a second cylinder chamber adjacent to the first cylinder chamber in a width direction, the extension space has a first extension space formed in the first cylinder chamber, and a second extension space formed in the second cylinder chamber, the intake valve has a first intake valve attached to the first extension space, and a second intake valve formed in the second extension space, the exhaust valve has a first exhaust valve attached to the first extension space, and a second exhaust valve formed in the second extension space, and the spark plug has a first spark plug attached to the first extension space, and a second spark plug attached to the second extension space. According to the engine of the present invention, the cylinder chambers can be brought close to each other, the width occupied by a plurality of cylinder chambers can be shortened, and this contributes to miniaturization of the engine.

Also, in the engine of the present invention, the first spark plug is arranged outward in the width direction from the first exhaust valve, and the second spark plug is arranged outward in the width direction from the second exhaust valve. According to the engine of the present invention, the first spark plug and the second spark plug can be easily connected to a power supply unit that supplies electric power to the first spark plug and the second spark plug.

Also, in the engine of the present invention, the first cylinder chamber and the second cylinder chamber are formed inside an engine block, and the first spark plug and the second spark plug are arranged in installation holes that penetrate a side surface portion of the engine block. According to the engine of the present invention, by the first spark plug and the second spark plug being arranged so as to penetrate a side wall of the engine block, the first spark plug and the second spark plug can be arranged close to an end portion in the width direction of the engine. Therefore, the intake valve, exhaust valve, and the like can be arranged in a central portion in the width direction of the engine, the first cylinder chamber and the second cylinder chamber can be brought close to each other, and the configuration of the entire engine can be made compact.

### BRIEF DESCRIPTION OF DRAWINGS

FIG. 1 is a perspective view showing an engine according to an embodiment of the present invention.

FIG. 2A is a diagram showing the engine according to the embodiment of the present invention, and is a perspective view showing a first engine block.

FIG. 2B is a diagram showing the engine according to the embodiment of the present invention, and is a perspective view showing a second engine block.

FIG. 3A is a diagram showing the engine according to the embodiment of the present invention, and is a diagram showing a first contact surface of the first engine block.

FIG. 3B is a diagram showing the engine according to the embodiment of the present invention, and is a diagram showing a second contact surface of the second engine block.

FIG. 4 is a diagram showing the engine according to the embodiment of the present invention, and is a perspective view showing an engine unit and the like.

FIG. 5 is a diagram showing the engine according to the embodiment of the present invention, and is a cross-sectional view showing a wall portion of an engine block that forms a cylinder chamber and an extension space.

FIG. 6A is a diagram showing the engine according to the embodiment of the present invention, and is a perspective view showing a cylinder chamber, respective valves, and the like.

FIG. 6B is a diagram showing the engine according to the embodiment of the present invention, and is a perspective view showing the cylinder chamber, respective valves, and the like from another angle.

FIG. 7 is a diagram showing the engine according to the embodiment of the present invention, and is a top view showing a related configuration of respective valves and a spark plug.

FIG. 8 is a diagram showing the engine according to the embodiment of the present invention, and is a cutaway perspective view showing a configuration in which a spark plug penetrates an engine block.

FIG. 9 is a diagram showing the engine according to the embodiment of the present invention, and is a side view showing a first cylinder chamber, a first intake valve, and the like.

### DESCRIPTION OF EMBODIMENTS

Hereinafter, an engine 10 according to an embodiment of the present invention will be described in detail based on the drawings. In the following description, the front-rear direction refers to the direction in which pistons to be described later reciprocate along the axial direction of a cylinder chamber to be described later. The left-right direction refers to the direction in which cylinder spaces to be described later are arranged. Also, the left-right direction is synonymous with the width direction. In the following description, the same members are, in principle, assigned the same reference numerals, and repeated descriptions thereof are omitted. Furthermore, in the present embodiment, the configurations described in the claims are mainly illustrated and described. Therefore, parts of the engine 10 other than the configurations that it comprises, for example, a crankshaft rotation synchronization mechanism, a lubricating oil supply mechanism, a fuel supply mechanism, electrical components, a drive mechanism for driving respective valves and the like, a belt, and the like, are not illustrated.

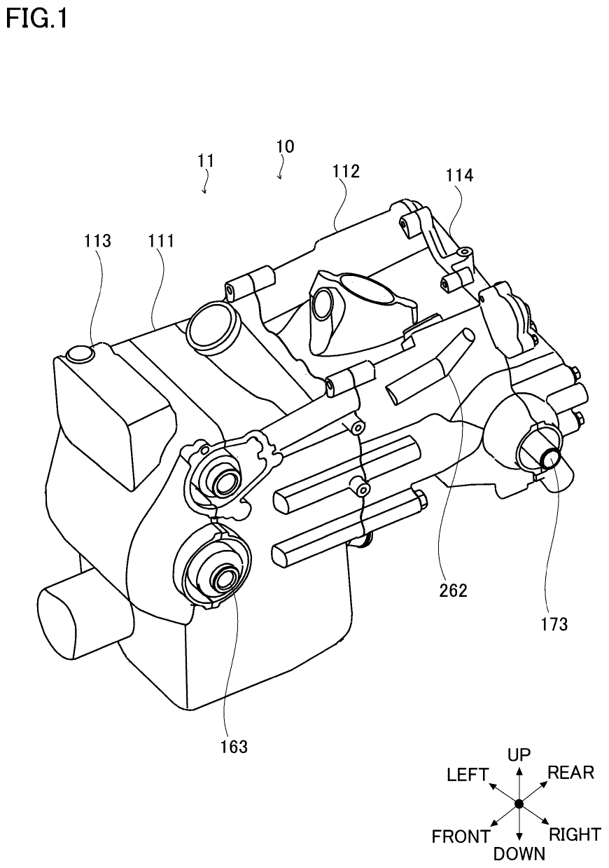

FIG. 1 is a perspective view showing the engine 10.

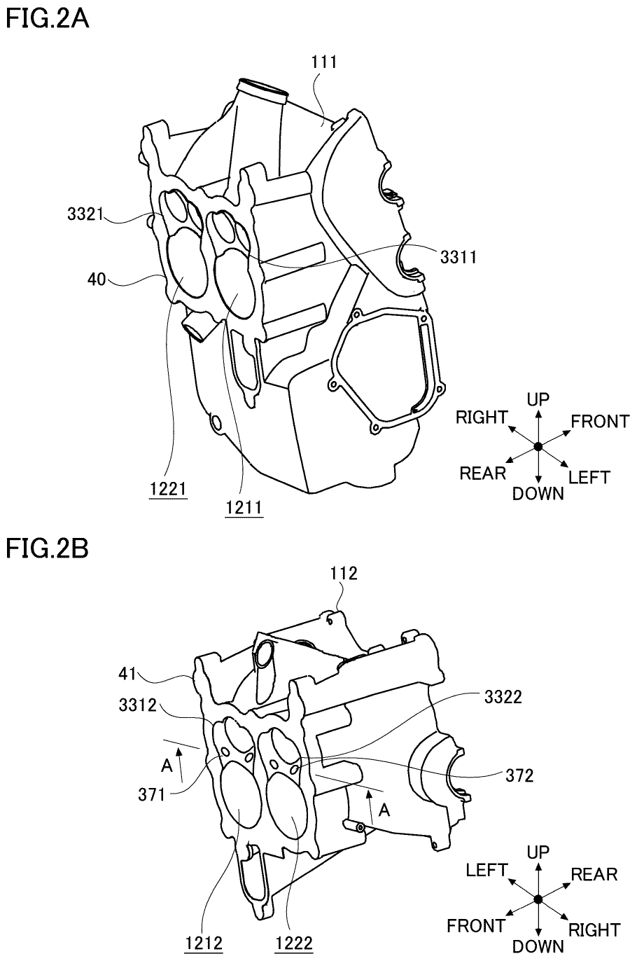

The engine 10 is an opposed-piston engine having a plurality of oppositely arranged pistons. The internal configuration and operation of the engine 10 will be described later with reference to FIG. 2A and subsequent figures.

The engine 10 is configured to be operated with gasoline, diesel oil, hydrogen, or the like as fuel. The engine 10 can be used as a drive source for various devices. The engine 10 is used as a drive source for vehicles, generators, water heaters, flight apparatuses, drones, series hybrid drones, parallel hybrid drones, and the like. A series hybrid drone refers to a drone that operates a generator by the engine 10, rotates a motor by electric power generated from the generator, rotates a rotor by the motor, and levitates an airframe in the air by lift generated by the rotation of the rotor. A parallel hybrid drone refers to a drone that mechanically rotates a main rotor by the engine, and levitates an airframe by lift generated by the rotation of the main rotor. The engine 10 of the present embodiment is an opposed-piston engine, and because it is lightweight and has low vibration, it is particularly suitable as a drive source for series hybrid drones, parallel hybrid drones, and the like.

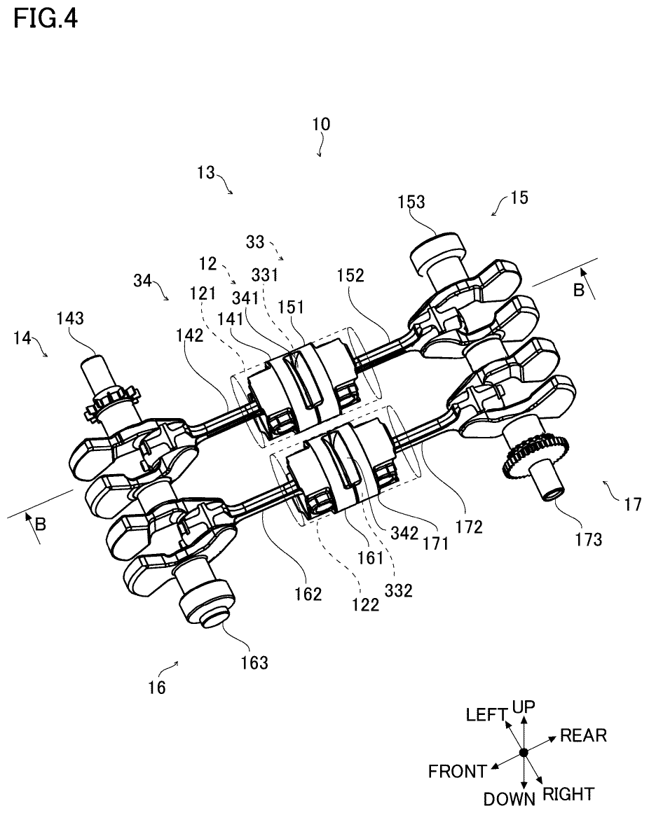

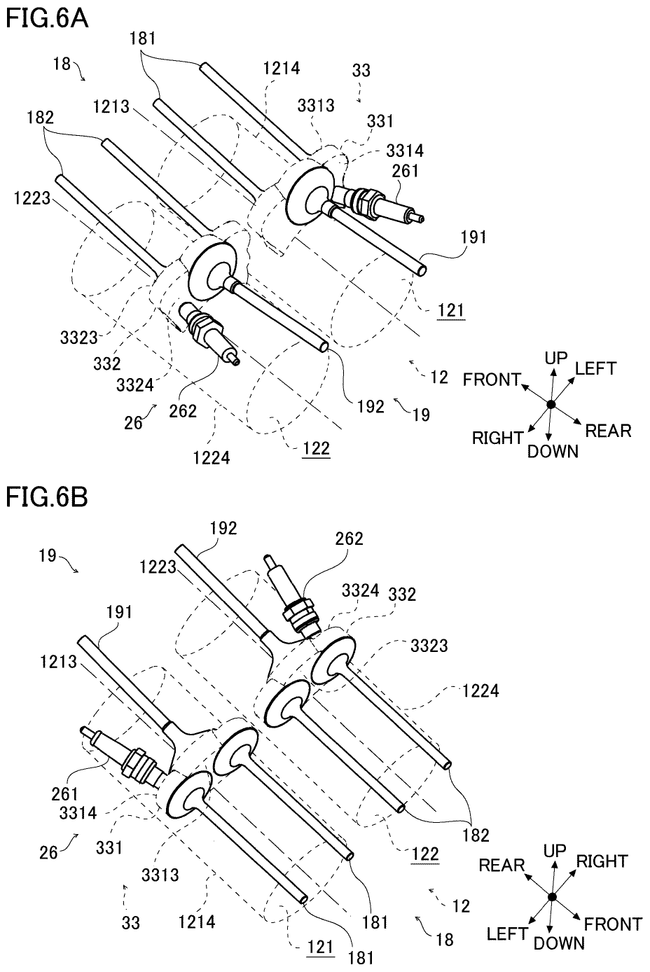

Specifically, the engine 10 mainly comprises: a cylinder chamber 12, an intake valve 18, and an exhaust valve 19. These respective parts constituting the engine 10 are housed in an engine block 11. The configuration of the cylinder chamber 12 and the like will be described with reference to FIG. 4 and the like. The intake valve 18, the exhaust valve 19, and the like will be described with reference to FIG. 6A and the like.

Also, the engine 10 has an engine block 11 that is a main body part. The engine block 11 is made of, for example, a cast aluminum alloy or the like. The engine block 11 is composed of a first engine block 111, a second engine block 112, a third engine block 113, and a fourth engine block 114. These respective parts are fastened to each other by fastening members such as stud bolts (not shown).

On the right side surface of the engine 10, a third crankshaft 163 and a fourth crankshaft 173 are led out. From the third crankshaft 163 and the fourth crankshaft 173, rotational power can be taken out to the outside. Also, a crankshaft can also be led out from the left side surface of the engine 10, and rotational power can also be taken out to the outside from this crankshaft.

Also, a second spark plug 262 is attached to the right side surface of the engine block 11. Similarly, on the left side surface of the engine block 11 also, a first spark plug 261 (not shown here) is attached. The first spark plug 261 and the second spark plug 262 penetrate respective side surface portions of the second engine block 112, and electrodes formed at their tips are exposed to an extension space 33 to be described later. This configuration will be described later with reference to FIG. 6A and the like.

FIG. 2A is a perspective view showing the first engine block 111.

Referring to FIG. 2A, the surface of the first engine block 111 facing rearward is taken as a first contact surface 40. The first contact surface 40 is a flat surface, and contacts a second contact surface 41 of a second engine block 112 to be described later.

The first engine block 111 has a first cylinder chamber front part 1211 and a second cylinder chamber front part 1221 formed in a substantially cylindrical shape extending forward from the first contact surface 40. The first cylinder chamber front part 1211 and the second cylinder chamber front part 1221 are adjacent along the left-right direction. The first cylinder chamber front part 1211 is a substantially cylindrical space, and forms a front portion of a first cylinder chamber 121 to be described later. The second cylinder chamber front part 1221 is a substantially cylindrical space, and forms a front portion of a second cylinder chamber 122 to be described later.

A first extension space front part 3311 is a portion where the first contact surface 40 is recessed forward, and is continuous with an upper end of the first cylinder chamber front part 1211. The first extension space front part 3311 constitutes a front portion of a first extension space 331 to be described later.

A second extension space front part 3321 is a portion where the first contact surface 40 is recessed forward, and is continuous with an upper end of the second cylinder chamber front part 1221. The second extension space front part 3321 constitutes a front portion of a second extension space 332 to be described later.

Referring to FIG. 2B, the surface of the second engine block 112 facing forward is taken as a second contact surface 41. The second contact surface 41 is a flat surface, and contacts the first contact surface 40 of the aforementioned first engine block 111.

The second engine block 112 has a first cylinder chamber rear part 1212 and a second cylinder chamber rear part 1222 formed extending rearward from the second contact surface 41. The first cylinder chamber rear part 1212 and the second cylinder chamber rear part 1222 are adjacent along the left-right direction. The first cylinder chamber rear part 1212 is a substantially cylindrical space, and forms a rear portion of a first cylinder chamber 121 to be described later. The second cylinder chamber rear part 1222 is a substantially cylindrical space, and forms a rear portion of a second cylinder chamber 122 to be described later.

A first extension space rear part 3312 is a portion where the second contact surface 41 is recessed rearward, and is continuous with an upper end of the first cylinder chamber rear part 1212. The first extension space rear part 3312, together with the aforementioned first extension space front part 3311, constitutes a first extension space 331 to be described later.

A second extension space rear part 3322 is a portion where the second contact surface 41 is recessed rearward, and is continuous with an upper end of the second cylinder chamber rear part 1222. The second extension space rear part 3322, together with the aforementioned second extension space front part 3321, constitutes a second extension space 332 to be described later.

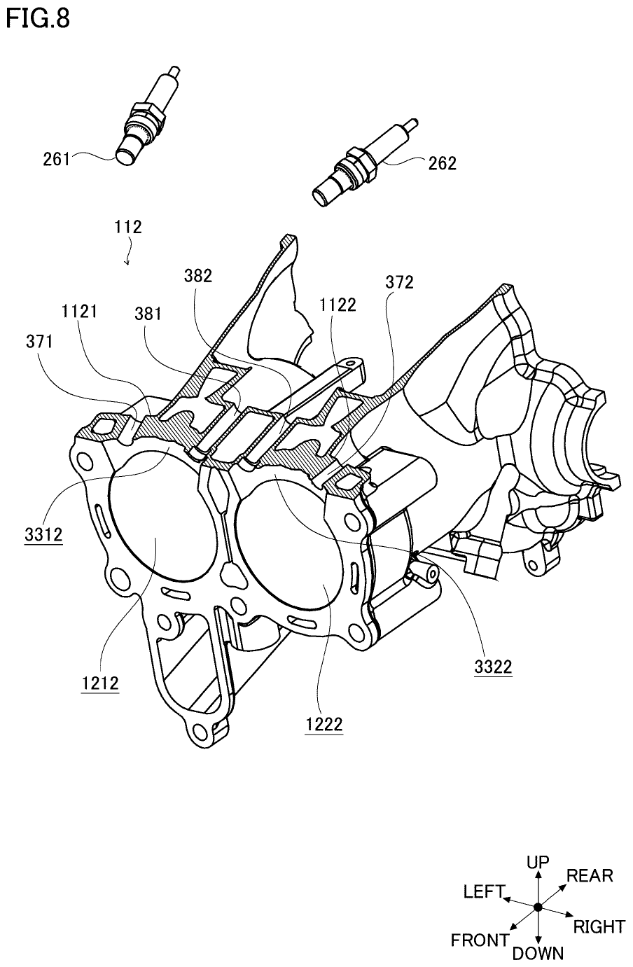

At a left side end portion of the first extension space rear part 3312, a first plug installation hole 371 is formed. Also, at a right side end portion of the second extension space rear part 3322, a second plug installation hole 372 is formed. The first plug installation hole 371 and the second plug installation hole 372 are substantially cylindrical holes that penetrate respective side surface portions of the second engine block 112, and will be described later with reference to FIG. 8.

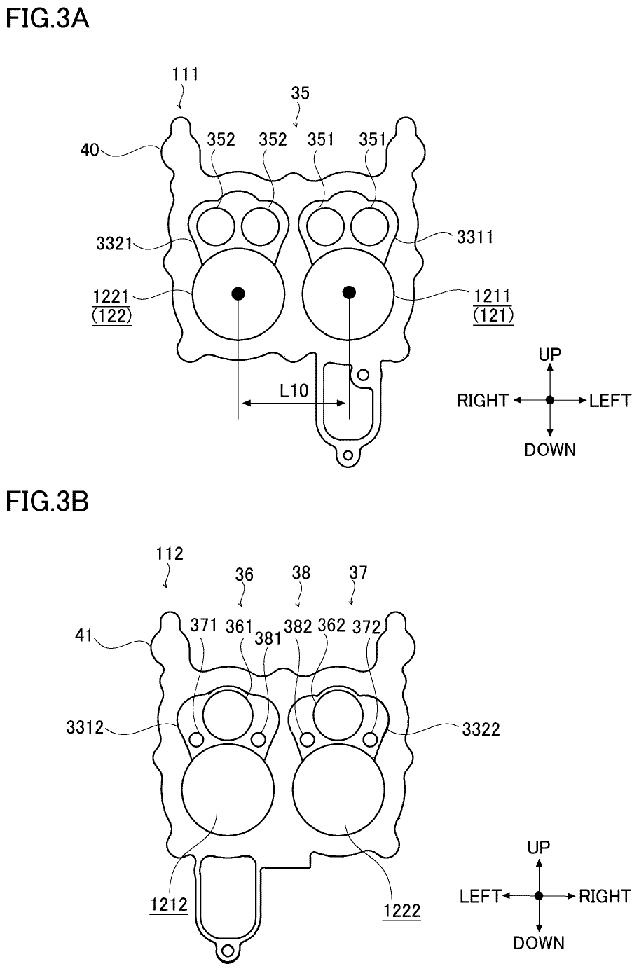

FIG. 3A is a diagram showing the first contact surface 40 of the first engine block 111. Intake valve installation holes 35 are formed in the first contact surface 40. The intake valve installation holes 35 have first intake valve installation holes 351 and second intake valve installation holes 352.

Two first intake valve installation holes 351 are formed inside the first extension space front part 3311. The first intake valve installation holes 351 are through-holes that circularly penetrate a wall portion of the first engine block 111 in the front-rear direction. First intake valves 181, to be described later, are respectively arranged in the first intake valve installation holes 351.

Two second intake valve installation holes 352 are formed inside the second extension space front part 3321. The second intake valve installation holes 352 are through-holes that circularly penetrate a wall portion formed inside the first engine block 111. Second intake valves 182, to be described later, are respectively arranged in the second intake valve installation holes 352.

FIG. 3B is a diagram showing the second contact surface 41 of the second engine block 112. Exhaust valve installation holes 36, plug installation holes 37, and decompression valve installation holes 38 are formed in the second contact surface 41. The exhaust valve installation holes 36 have a first exhaust valve installation hole 361 and a second exhaust valve installation hole 362. The plug installation holes 37 have a first plug installation hole 371 and a second plug installation hole 372. The decompression valve installation holes 38 have a first decompression valve installation hole 381 and a second decompression valve installation hole 382. Here, the exhaust valve installation holes 36 are formed larger than the aforementioned intake valve installation holes 35. For example, the area of the exhaust valve installation holes 36 is about twice that of the intake valve installation holes 35.

The first exhaust valve installation hole 361 is a hole portion formed in the first extension space rear part 3312. The first exhaust valve installation hole 361 circularly penetrates a wall portion formed inside the second engine block 112. A first exhaust valve 191, to be described later, is arranged in the first exhaust valve installation hole 361.

The first plug installation hole 371 is a through-hole formed in a lower part on a left side, which is outward in the width direction, inside the first extension space rear part 3312. The first plug installation hole 371 is a through-hole that penetrates a left side surface portion of the second engine block 112. That is, a front end portion of the first plug installation hole 371 opens into the first extension space rear part 3312. Also, a rear end portion of the first plug installation hole 371 opens to the outside from the left side surface portion of the second engine block 112. A front end portion of a first spark plug 261, to be described later, is inserted into the first plug installation hole 371.

The first decompression valve installation hole 381 is a through-hole formed in a lower part on a right side, which is inward in the width direction, inside the first extension space rear part 3312. The first decompression valve installation hole 381 is a hole that penetrates a wall portion formed inside the second engine block 112. In the first decompression valve installation hole 381, a decompression valve (not shown here) is installed.

The second exhaust valve installation hole 362 is a hole portion formed in the second extension space rear part 3322. The second exhaust valve installation hole 362 circularly penetrates a wall portion formed inside the second engine block 112. A second exhaust valve 192, to be described later, is arranged in the second exhaust valve installation hole 362.

The second plug installation hole 372 is a through-hole formed in a lower part on a right side, which is outward in the width direction, inside the second plug installation hole 372. The second plug installation hole 372 is a through-hole that penetrates a right side surface portion of the second engine block 112. That is, a front end portion of the second plug installation hole 372 opens into the second extension space rear part 3322. Also, a rear end portion of the second plug installation hole 372 opens to the outside from the right side surface portion of the second engine block 112. A front end portion of a second spark plug 262, to be described later, is inserted into the second plug installation hole 372.

The second decompression valve installation hole 382 is a through-hole formed in a lower part on a left side, which is inward in the width direction, inside the second extension space rear part 3322. The second decompression valve installation hole 382 is a hole that penetrates a wall portion formed inside the second engine block 112. In the second decompression valve installation hole 382, a decompression valve (not shown here) is installed.

Referring to FIG. 3A and FIG. 3B, in the present embodiment, as described above, the intake valve installation holes 35 are formed in the first engine block 111, and the exhaust valve installation holes 36 and the plug installation holes 37 are formed in the second engine block 112. With this configuration, a distance L10 between a central axis of the first cylinder chamber 121 and a central axis of the second cylinder chamber 122, shown in FIG. 3A, can be shortened. The reason for this is because the exhaust valve installation holes 36, the plug installation holes 37, and the decompression valve installation holes 38 are consolidated on the side of the second engine block 112, and respective valves and the like arranged in these installation holes can also be consolidated on the side of the second engine block 112.

FIG. 4 is a perspective view of an engine unit 13 housed in the aforementioned engine block 11, as viewed from the front.

The engine unit 13 has a first engine part 14, a second engine part 15, a third engine part 16, and a fourth engine part 17. The first engine part 14 and the second engine part 15 constitute one opposed engine part. The third engine part 16 and the fourth engine part 17 constitute one opposed engine part. Because the engine 10 has a plurality of opposed engine parts, high output can be achieved while ensuring lightweightness and low vibration of the engine 10.

The cylinder chamber 12 has a first cylinder chamber 121, and a second cylinder chamber 122 adjacent to the first cylinder chamber 121. The first cylinder chamber 121 and the second cylinder chamber 122 are adjacent along the left-right direction. In FIG. 4, the first cylinder chamber 121 and the second cylinder chamber 122 are indicated by dotted lines. Inside the first cylinder chamber 121, oppositely arranged first piston 141 and second piston 151 are arranged so as to reciprocate. Inside the second cylinder chamber 122, oppositely arranged third piston 161 and fourth piston 171 are arranged so as to reciprocate.

The first engine part 14 has a first piston 141, a first connecting rod 142, and a first crankshaft 143. The first connecting rod 142 rotatably connects the first piston 141 and the first crankshaft 143.

The second engine part 15 is arranged so as to oppose the first engine part 14. The second engine part 15 has a second piston 151, a second connecting rod 152, and a second crankshaft 153. The second connecting rod 152 rotatably connects the second piston 151 and the second crankshaft 153.

The third engine part 16 has a third piston 161, a third connecting rod 162, and a third crankshaft 163. The third connecting rod 162 rotatably connects the third piston 161 and the third crankshaft 163.

The fourth engine part 17 is arranged so as to oppose the third engine part 16. The fourth engine part 17 has a fourth piston 171, a fourth connecting rod 172, and a fourth crankshaft 173. The fourth connecting rod 172 rotatably connects the fourth piston 171 and the fourth crankshaft 173.

The first crankshaft 143 of the first engine part 14 and the third crankshaft 163 of the third engine part 16 are integrally continuous. Therefore, the first piston 141 of the first engine part 14 and the third piston 161 of the third engine part 16 reciprocate simultaneously.

Similarly, the second crankshaft 153 of the second engine part 15 and the fourth crankshaft 173 of the fourth engine part 17 are integrally continuous. Therefore, the second piston 151 of the second crankshaft 153 and the fourth piston 171 of the fourth engine part 17 reciprocate simultaneously.

The engine unit 13 has a configuration in which an opposed engine portion composed of the first engine part 14 and the second engine part 15, and an opposed engine portion composed of the third engine part 16 and the fourth engine part 17 are arranged side by side along the left-right direction. Also, the first engine part 14 and the third engine part 16 rotate the first crankshaft 143 and the third crankshaft 163. Furthermore, the second engine part 15 and the fourth engine part 17 rotate the second crankshaft 153 and the fourth crankshaft 173. With this configuration, large power can be generated even with a compact configuration.

The extension space 33 is a space extending upward, which is a lateral direction, from an intermediate portion of the cylinder chamber 12 in the front-rear direction. The extension space 33 has a first extension space 331 and a second extension space 332. The first extension space 331 is a space extending upward from an intermediate portion in the front-rear direction of the first cylinder chamber 121. The second extension space 332 is a space extending upward from an intermediate portion in the front-rear direction of the second cylinder chamber 122. The first extension space 331 and the second extension space 332 are portions where respective valves and plugs are installed, as will be described later. The specific shape and the like of the extension space 33 are shown in FIG. 6A and the like.

A combustion chamber 34 is a space sandwiched by pistons inside the cylinder chamber 12. The combustion chamber 34 has a first combustion chamber 341 and a second combustion chamber 342. The first combustion chamber 341 is a space inside the first cylinder chamber 121, sandwiched by the first piston 141 and the second piston 151, where an air-fuel mixture combusts. The first combustion chamber 341 is continuous with the first extension space 331. The second combustion chamber 342 is a space inside the second cylinder chamber 122, sandwiched by the third piston 161 and the fourth piston 171, where an air-fuel mixture combusts. The second combustion chamber 342 is continuous with the second extension space 332.

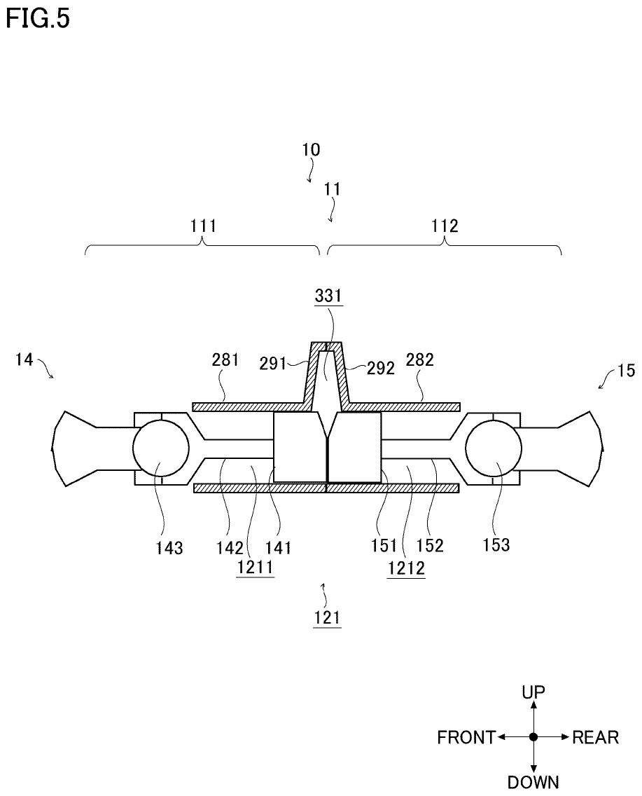

FIG. 5 is a cross-sectional view along the line B-B in FIG. 4, and shows a wall portion of the engine block 11 that forms the first cylinder chamber 121 and the first extension space 331.

As described above, the first cylinder chamber 121 is a space having a substantially cylindrical shape. The first cylinder chamber 121 has a first cylinder chamber front part 1211 on a front side, and a first cylinder chamber rear part 1212 connected to a rear end of the first cylinder chamber front part 1211. At a substantially central portion in the front-rear direction of the first cylinder chamber 121, the first extension space 331 projects upward from an upper surface of the first cylinder chamber 121. The first cylinder chamber front part 1211, the first cylinder chamber rear part 1212, and the first extension space 331 communicate with each other.

The first cylinder chamber 121 and the first extension space 331 of such a configuration are spaces surrounded by a wall portion formed inside the engine block 11.

Specifically, the first cylinder chamber front part 1211 is a substantially cylindrical space surrounded by a first cylinder wall portion 281. The first cylinder wall portion 281 is a tubular wall formed inside the first engine block 111. A front end and a rear end of the first cylinder wall portion 281 are in an open state.

The first cylinder chamber rear part 1212 is a substantially cylindrical space surrounded by a second cylinder wall portion 282. The second cylinder wall portion 282 is a tubular wall formed inside the second engine block 112. A front end and a rear end of the second cylinder wall portion 282 are in an open state.

The first extension space 331 is a space surrounded by a first extension wall portion 291 and a second extension wall portion 292. The first extension wall portion 291 is a substantially tongue-shaped portion extending upward from an upper end portion of the first cylinder wall portion 281 at a rear end of the first cylinder wall portion 281. The second extension wall portion 292 is a substantially tongue-shaped portion extending upward from an upper end portion of the second cylinder wall portion 282 at a front end of the second cylinder wall portion 282.

FIG. 6A is a perspective view showing the cylinder chamber 12, respective valves, and the like from a rear right side. FIG. 6B is a perspective view showing the cylinder chamber 12, respective valves, and the like from a front left side.

As shown in FIG. 6A and FIG. 6B, as the cylinder chamber 12, the aforementioned first cylinder chamber 121 and second cylinder chamber 122 are illustrated.

The extension space 33 is connected to the cylinder chamber 12, and is a space that serves as a starting point of combustion in a combustion stroke to be described later. Specifically, the extension space 33 is a space extending continuously upward from a central portion in the front-rear direction of the cylinder chamber 12. A first extension space 331 is formed in the first cylinder chamber 121, and a second extension space 332 is formed in the second cylinder chamber 122.

Referring to FIG. 6A, the first cylinder chamber 121 and the first extension space 331 will be described. The first cylinder chamber 121 is a substantially cylindrical space having a central axis 1213 extending along the front-rear direction. The first cylinder chamber 121 has a first side surface 1214. The first side surface 1214 is a surface constituted by an inner surface of the first cylinder wall portion 281 shown in FIG. 5. The first extension space 331 extends from the first side surface 1214. Specifically, the first extension space 331 is a space extending upward, which is a direction orthogonal to the first central axis 1213 of the first cylinder chamber 121. The first extension space 331 communicates with the first cylinder chamber 121.

The second cylinder chamber 122 is a substantially cylindrical space having a second central axis 1223 extending along the front-rear direction. The second cylinder chamber 122 has a second side surface 1224. The shape of the second side surface 1224 is similar to the aforementioned first side surface 1214. The second extension space 332 extends from the second side surface 1224. Specifically, the second extension space 332 is a space extending upward, which is a direction orthogonal to the second central axis 1223 of the second cylinder chamber 122. The second extension space 332 communicates with the second cylinder chamber 122.

The first extension space 331 is a substantially tongue-shaped portion having a largest surface facing in the front-rear direction. The first extension space 331 has a first side surface 3313 and a second side surface 3314. The first side surface 3313 is a surface facing forward. The second side surface 3314 is a surface facing rearward.

The second extension space 332 is a substantially tongue-shaped portion having a largest surface facing in the front-rear direction. The second extension space 332 has a first side surface 3323 and a second side surface 3324. The first side surface 3323 is a surface facing forward. The second side surface 3324 is a surface facing rearward.

The intake valve 18 has a first intake valve 181 and a second intake valve 182.

The first intake valve 181 is provided so as to be capable of advancing and retreating with respect to the first side surface 3313 of the first extension space 331 from a front side. Here, two first intake valves 181 are provided. The first intake valves 181 are respectively attached to the first intake valve installation holes 351 shown in FIG. 3A. The first intake valve 181 is for intaking an air-fuel mixture into the first cylinder chamber 121. By the first intake valve 181 entering the first extension space 331, the first intake valve installation hole 351 shown in FIG. 3A is opened, and intake into the first extension space 331 and the first cylinder chamber 121 can be performed. On the other hand, by the first intake valve 181 retreating from the first extension space 331, the first intake valve installation hole 351 shown in FIG. 3A is closed.

The second intake valve 182 is provided so as to be capable of advancing and retreating with respect to the first side surface 3323 of the second extension space 332 from a front side. Here, two second intake valves 182 are provided. The second intake valves 182 are respectively attached to the second intake valve installation holes 352 shown in FIG. 3A. The second intake valve 182 is for intaking an air-fuel mixture into the second cylinder chamber 122. By the second intake valve 182 entering the second extension space 332, the second intake valve installation hole 352 shown in FIG. 3A is opened, and intake into the second extension space 332 and the second cylinder chamber 122 can be performed. On the other hand, by the second intake valve 182 retreating from the second extension space 332, the second intake valve installation hole 352 shown in FIG. 3A is closed.

The exhaust valve 19 has a first exhaust valve 191 and a second exhaust valve 192.

The first exhaust valve 191 is provided so as to be capable of advancing and retreating with respect to the second side surface 3314 of the first extension space 331 from a rear side. Here, one first exhaust valve 191 is provided. The first exhaust valve 191 is attached to the first exhaust valve installation hole 361 shown in FIG. 3B. The first exhaust valve 191 is for exhausting gas after combustion from the first cylinder chamber 121. By the first exhaust valve 191 entering the first extension space 331, the first exhaust valve installation hole 361 shown in FIG. 3B is opened, and exhaust from inside the first cylinder chamber 121 via the first exhaust valve installation hole 361 can be performed. On the other hand, by the first exhaust valve 191 retreating from the first extension space 331, the first exhaust valve installation hole 361 shown in FIG. 3B is closed.

The second exhaust valve 192 is provided so as to be capable of advancing and retreating with respect to the second side surface 3324 of the second extension space 332 from a rear side. Here, one second exhaust valve 192 is provided. The second exhaust valve 192 is attached to the second exhaust valve installation hole 362 shown in FIG. 3B. The second exhaust valve 192 is for exhausting gas after combustion from the second cylinder chamber 122. By the second exhaust valve 192 entering the second extension space 332, the second exhaust valve installation hole 362 shown in FIG. 3B is opened, and exhaust from inside the second cylinder chamber 122 via the second exhaust valve installation hole 362 can be performed. On the other hand, by the second exhaust valve 192 retreating from the second extension space 332, the second exhaust valve installation hole 362 shown in FIG. 3B is closed.

The number of intake valves 18 is greater than the number of exhaust valves 19. For example, regarding the first extension space 331, the number of exhaust valves 19 is one, and the number of intake valves 18 is two. By doing so, by the spark plug 26 and the like being exposed to the extension space 33 from the side of the exhaust valves 19, which are fewer in number, the space around the extension space 33 can be used effectively.

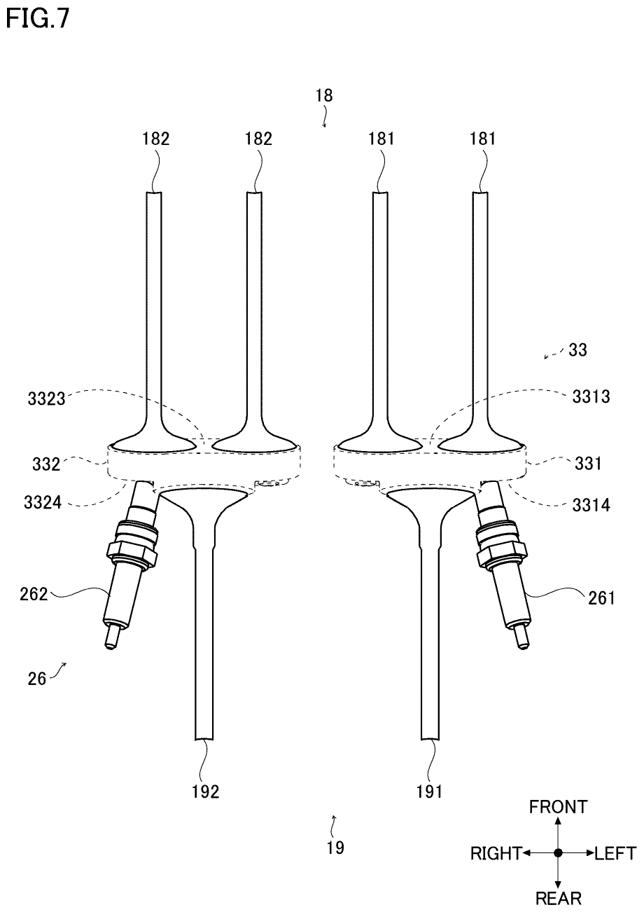

FIG. 7 is a top view showing a related configuration of respective valves and a spark plug.

The spark plug 26 is a member arranged on the side where the exhaust valve 19 is provided, that is, on a rear side of the extension space 33. An electrode formed at a tip of the spark plug 26 is arranged inside the extension space 33. The spark plug 26 has a first spark plug 261 and a second spark plug 262.

The first spark plug 261 is a member arranged outward in the width direction from the first exhaust valve 191, that is, on a left side. A front end portion of the first spark plug 261 penetrates the second side surface 3314, and is arranged inside the first extension space 331. Also, the first spark plug 261 is inclined rightward, which is inward in the width direction, as it goes forward. Furthermore, the first spark plug 261 is inclined downward as it goes forward.

The second spark plug 262 is a member arranged outward in the width direction from the second exhaust valve 192, that is, on a right side. A front end portion of the second spark plug 262 penetrates the second side surface 3324, and is arranged inside the second extension space 332. Also, the second spark plug 262 is inclined leftward, which is inward in the width direction, as it goes forward. Furthermore, the second spark plug 262 is inclined downward as it goes forward.

By arranging the first spark plug 261 and the second spark plug 262 outward in the width direction, wiring for supplying electric power to the first spark plug 261 and the second spark plug 262 can be easily routed. Furthermore, as will be described later, the first spark plug 261 and the second spark plug 262 can be arranged at predetermined locations by penetrating a side wall of the engine block 11.

FIG. 8 is a cutaway perspective view showing a lower portion of the second engine block 112. Here, a lower portion of the second engine block 112, cut along the line A-A shown in FIG. 2B, is shown. Also, in this cutaway view, hatching is applied to a portion corresponding to a thick-walled portion of the second engine block 112. Furthermore, in FIG. 8, the first spark plug 261 and the second spark plug 262 are shown separated above the second engine block 112.

A side surface portion 1121 is a thick portion of a side surface of the second engine block 112, formed in an immediately rear portion of the first extension space rear part 3312. In other words, the side surface portion 1121 is a wall portion of the second engine block 112 formed between the first extension space rear part 3312 and the outside.

A side surface portion 1122 is a thick portion of a side surface of the second engine block 112, formed in an immediately rear portion of the second extension space rear part 3322. In other words, the side surface portion 1122 is a wall portion of the second engine block 112 formed between the second extension space rear part 3322 and the outside.

The second engine block 112 has, as installation holes, a first plug installation hole 371 and a second plug installation hole 372.

The first plug installation hole 371 is a substantially cylindrical hole portion configured to penetrate the side surface portion 1121. A front end of the first plug installation hole 371 reaches the first extension space rear part 3312. A rear end of the first plug installation hole 371 reaches the outside from a rear end of the side surface portion 1121. A front end portion of the first spark plug 261 is inserted into the first plug installation hole 371 of such a configuration. By doing so, the first spark plug 261 can be arranged in close contact with a left side surface of the second engine block 112, the first spark plug 261 does not protrude to the outside, and the engine 10 can be made compact overall.

The second plug installation hole 372 is a substantially cylindrical hole portion configured to penetrate the side surface portion 1122. A front end of the second plug installation hole 372 reaches the second extension space rear part 3322. A rear end of the second plug installation hole 372 reaches the outside from a rear end of the side surface portion 1122. A front end portion of the aforementioned second spark plug 262 is inserted into the side surface portion 1122 of such a configuration. By doing so, the second spark plug 262 can be arranged in close contact with a right side surface of the second engine block 112, the second spark plug 262 does not protrude to the outside, and the engine 10 can be made compact overall.

Also, a first decompression valve installation hole 381 and a second decompression valve installation hole 382 are formed in the second engine block 112. The first decompression valve installation hole 381 is a hole portion that penetrates the side surface portion 1121, and a decompression valve (not shown) is installed. The second decompression valve installation hole 382 is a hole portion that penetrates the side surface portion 1122, and a decompression valve (not shown) is installed.

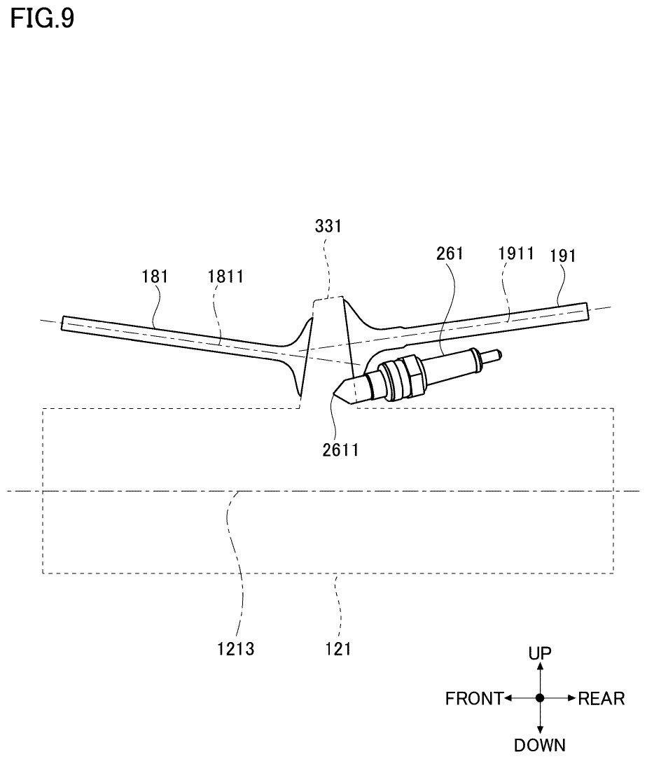

Referring to FIG. 9, a related configuration of the first intake valve 181, the first exhaust valve 191, and the first spark plug 261 will be described.

As described above, the first intake valve 181, the first exhaust valve 191, and the first spark plug 261 are arranged in the first extension space 331. In the present embodiment, the first spark plug 261 is arranged such that flame propagation inside the first extension space 331 and the first cylinder chamber 121 becomes favorable.

In FIG. 9, a central axis 1811 of the first intake valve 181 and its extension line are indicated by a dashed-dotted line. A central axis 1911 of the first exhaust valve 191 and its extension line are indicated by a dashed-dotted line. Also, inside the first extension space 331, an electrode 2611 formed at a tip of the first spark plug 261 is arranged. Furthermore, a central axis 1213 of the first cylinder chamber 121, which has a cylindrical shape, is indicated by a dashed-dotted line.

Inside the first extension space 331, the electrode 2611 is arranged on a lower side than extension lines of the central axis 1811 and the central axis 1911. In other words, the electrode 2611 is closer to the central axis 1213 of the first cylinder chamber 121 than the extension lines of the central axis 1811 and the central axis 1911. By doing so, flame propagation in the combustion stroke of the engine 10 can be performed more effectively and rapidly. Specifically, in the combustion stroke, by the electrode 2611 sparking, an air-fuel mixture existing inside the first extension space 331 and the first cylinder chamber 121 combusts. In the present embodiment, the electrode 2611 is brought close to the central axis 1213 of the first cylinder chamber 121. Therefore, in the combustion stroke, when the electrode 2611 sparks, flame propagates favorably inside the first extension space 331 and the first cylinder chamber 121.

Such matters are also similar with respect to the aforementioned second cylinder chamber 122.

The first engine part 14 and the second engine part 15 of the engine unit 13 of the above-described configuration operate by repeating an intake stroke, a compression stroke, a combustion stroke, and an exhaust stroke as follows.

In the intake stroke, referring to FIG. 4, by the first piston 141 and the second piston 151 moving from a central portion toward an outer side inside the first cylinder chamber 121, an air-fuel mixture, which is a mixture of fuel and air, is sucked into the first cylinder chamber 121. Simultaneously, the first crankshaft 143 and the second crankshaft 153 rotate. Referring to FIG. 6A and FIG. 6B, in the intake stroke, the first intake valve 181 brings the first extension space 331 into an open state, while the first exhaust valve 191 brings the first extension space 331 into a closed state. Therefore, the air-fuel mixture can be sucked into the first cylinder chamber 121 via the first intake valve installation hole 351 and the first extension space 331 shown in FIG. 3A.

In the compression stroke, referring to FIG. 4, due to inertia of the rotating first crankshaft 143 and second crankshaft 153, the first piston 141 and the second piston 151 are pushed out toward the central portion, and the air-fuel mixture is compressed inside the first cylinder chamber 121. Referring to FIG. 6A, the first intake valve 181 brings the first extension space 331 into a closed state, and the first exhaust valve 191 brings the first extension space 331 into a closed state. Therefore, the first extension space 331 and the first cylinder chamber 121 enter a closed state, and the air-fuel mixture can be compressed inside the first cylinder chamber 121.

In the combustion stroke, by the first spark plug 261 shown in FIG. 6A igniting in the first extension space 331, the air-fuel mixture combusts inside the first extension space 331 and the first cylinder chamber 121 shown in FIG. 4, and thereby the first piston 141 and the second piston 151 are pushed out to an outer end portion, which is a bottom dead center. Referring to FIG. 6A, similarly to the compression stroke, in this stroke, the first intake valve 181 brings the first extension space 331 into a closed state, and the first exhaust valve 191 brings the first extension space 331 into a closed state. That is, the states of the first intake valve 181 and the first exhaust valve 191 are similar to the aforementioned compression stroke. Here, in the present embodiment, as shown in FIG. 6A, the first spark plug 261 is inserted into the first extension space 331 from the second side surface 3314. Therefore, a tip electrode of the first spark plug 261 that performs ignition can be arranged close to a center of the first extension space 331, and flame propagation inside the first extension space 331 and the first cylinder chamber 121 can be improved.

In the exhaust stroke, referring to FIG. 4, due to inertia of the rotating first crankshaft 143 and second crankshaft 153, the first piston 141 and the second piston 151 are pushed inward, and gas after combustion existing inside the first cylinder chamber 121 is discharged to the outside. Referring to FIG. 6A and FIG. 6B, the first intake valve 181 brings the first extension space 331 into a closed state, while the first exhaust valve 191 brings the first extension space 331 into an open state. Thereby, the gas after combustion inside the first cylinder chamber 121 is released to the outside from the first exhaust valve installation hole 361 shown in FIG. 3B.

Such operation is also similar with respect to the third engine part 16, the fourth engine part 17, the second intake valve 182, and the second exhaust valve 192.

In the engine unit 13 according to the present embodiment, the stroke can be divided by the two pistons, the first piston 141 and the second piston 151, that reciprocate inside one first cylinder chamber 121. Therefore, compared to a normal engine, the compression ratio of the mixed gas can be increased. Also, because the first piston 141 and the second piston 151 oppose each other inside the first cylinder chamber 121, a cylinder head required in a general engine becomes unnecessary, and the configuration of the engine unit 13 is simple and lightweight. Also, respective members constituting the engine unit 13, that is, the first piston 141 and the second piston 151, the first crankshaft 143 and the second crankshaft 153, and the like, are arranged opposing each other, and operate so as to oppose each other. From this, vibrations generated from the respective members of the engine unit 13 are cancelled out, and vibrations generated to the outside from the entire engine unit 13 can be reduced. Therefore, by mounting the engine unit 13 having such a structure on a flight apparatus, miniaturization, weight reduction, and low vibration of the flight apparatus can be achieved. In particular, by reducing vibration, adverse effects on arithmetic control devices such as attitude control and motor output control, and precision instruments such as GPS sensors can be prevented. Also, it is possible to prevent delivery cargo transported by the flight apparatus from being damaged by vibration.

Although the embodiment of the present invention has been described above, the present invention is not limited thereto, and modifications can be made without departing from the gist of the present invention. Also, the respective forms described above can be combined with each other.

Referring to FIG. 6A, although the present embodiment had a plurality of cylinder chambers 12, the number of cylinder chambers 12 may also be one. That is, the engine 10 of the present embodiment may also be a single-cylinder engine.

Referring to FIG. 6A, in the present embodiment, one first spark plug 261 was arranged with respect to the first extension space 331, but a plurality of, for example, two, first spark plugs 261 may also be arranged. By doing so, flame propagation inside the first extension space 331 can be performed even more effectively. Such matters are also similar with respect to the second extension space 332.

### REFERENCE SIGNS LIST

10 Engine
11 Engine block
111 First engine block
112 Second engine block
1121 Side surface portion
1122 Side surface portion
113 Third engine block
114 Fourth engine block
12 Cylinder chamber
121 First cylinder chamber
1211 First cylinder chamber front part
1212 First cylinder chamber rear part
1213 First central axis
1214 First side surface
122 Second cylinder chamber
1221 Second cylinder chamber front part
1222 Second cylinder chamber rear part
1223 Second central axis
1224 Second side surface
13 Engine unit
14 First engine part
141 First piston
142 First connecting rod
143 First crankshaft
15 Second engine part
151 Second piston
152 Second connecting rod
153 Second crankshaft
16 Third engine part
161 Third piston
162 Third connecting rod
163 Third crankshaft
17 Fourth engine part
171 Fourth piston
172 Fourth connecting rod
173 Fourth crankshaft
18 Intake valve
181 First intake valve
1811 Central axis
182 Second intake valve
19 Exhaust valve
191 First exhaust valve
1911 Central axis
192 Second exhaust valve
20 Advancing/retreating mechanism
26 Spark plug
261 First spark plug
2611 Electrode
262 Second spark plug
281 First cylinder wall portion
282 Second cylinder wall portion
291 First extension wall portion
292 Second extension wall portion
33 Extension space
331 First extension space
3311 First extension space front part
3312 First extension space rear part
3313 First side surface
3314 Second side surface
332 Second extension space
3321 Second extension space front part
3322 Second extension space rear part
3323 First side surface
3324 Second side surface
34 Combustion chamber
341 First combustion chamber
342 Second combustion chamber
35 Intake valve installation hole
351 First intake valve installation hole
352 Second intake valve installation hole
36 Exhaust valve installation hole
361 First exhaust valve installation hole
362 Second exhaust valve installation hole
37 Plug installation hole
371 First plug installation hole
372 Second plug installation hole
38 Decompression valve installation hole
381 First decompression valve installation hole
382 Second decompression valve installation hole
40 First contact surface
41 Second contact surface Application No. Not Yet Assigned Docket No. P250483US00

1-6. (canceled)

7. An engine comprising: a cylinder chamber, an intake valve, an exhaust valve, and a spark plug,
wherein inside the cylinder chamber, opposing pistons are arranged so as to reciprocate, an extension space, which is a space extending from a side surface of the cylinder chamber along a direction orthogonal to a central axis of the cylinder chamber, is formed, on a first side surface of the extension space,
the intake valve is arranged, on a second side surface of the extension space, which opposes the first side surface, the exhaust valve and the spark plug are arranged, and inside the extension space, an electrode formed at a tip of the spark plug is closer to the central axis of the cylinder chamber than an extension line of a central axis of the intake valve and an extension line of a central axis of the exhaust valve.

8. The engine according to claim 7, wherein the number of the exhaust valves is less than the number of the intake valves.

9. The engine according to claim 7, wherein the cylinder chamber has a first cylinder chamber, and a second cylinder chamber adjacent to the first cylinder chamber in a width direction,
the extension space has a first extension space formed in the first cylinder chamber, and a second extension space formed in the second cylinder chamber,
the intake valve has a first intake valve attached to the first extension space, and a second intake valve attached to the second extension space,
the exhaust valve has a first exhaust valve attached to the first extension space, and a second exhaust valve attached to the second extension space, and
the spark plug has a first spark plug attached to the first extension space, and a second spark plug attached to the second extension space.

10. The engine according to claim 9, wherein the first spark plug is arranged outward in the width direction from the first exhaust valve, and
the second spark plug is arranged outward in the width direction from the second exhaust valve.

11. The engine according to claim 10, wherein the first cylinder chamber and the second cylinder chamber are formed inside an engine block, and
the first spark plug and the second spark plug are arranged in installation holes that penetrate a side surface portion of the engine block.
